(19) United States
(12) Patent Application Publication
(10) Pub. No.: US 2012/0092589 A1
(43) Pub. Date: Apr. 19, 2012

(54) BACK LIGHT MODULE AND LIQUID CRYSTAL DISPLAY DEVICE

(75) Inventor: Ruoyu MA, Beijing (CN)

(73) Assignee: BOE TECHNOLOGY GROUP CO., LTD., Beijing (CN)

(21) Appl. No.: 13/270,561

(22) Filed: Oct. 11, 2011

(30) Foreign Application Priority Data
Oct. 14, 2010 (CN) 201010512181.8

(51) Int. Cl. G02F 1/13357; F21V 9/14

(52) U.S. Cl. 349/62; 362/19

(57) ABSTRACT

A back light module comprising: a back light source; a guiding plate; and a PBS and an optical converter which are disposed between the back light source and the guiding plate. The PBS is adapted to split light emitted from the back light source into first polarized light and second polarized light with polarization directions perpendicular to each other, and the optical converter is adapted to convert the polarization direction of the second polarized light to be in the polarization direction of the first polarized light, and reflect the first polarized light or the converted second polarized light into the guiding plate. A liquid crystal display is also provided.

### BACKGROUND

Embodiments of the disclosed technology relate to a back light module and a liquid crystal display (LCD).

Liquid crystal displays are a kind of flat display devices which is most used at present. Thin film transistor liquid crystal displays (TFT-LCDs) have been dominating products in the LCD market.

Light emitted by a common back light source is similar to natural light without a certain polarization direction, and can be split into two beams of polarized light with polarization directions perpendicular to each other and having the same energy. In order to achieve a function of modulating light of liquid crystal, when the above back light sources are used, it is necessary to attach two polarizer to the outside of the liquid crystal panel. The polarizer attached to the side of a color filter substrate is generally referred to as a lower polarizer with a function of polarizing so as to transmit polarized light with a certain polarization direction. As compared with light provided by the back light source, the polarized light obtained through the lower polarizer undergoes an optical loss of 50%. The polarizer attached to the side of an array substrate is generally referred to as an upper polarizer with a function of analyzing. The polarizing directions of the upper polarizer and the lower polarizer can be either perpendicular or parallel to each other depending on the used display modes.

Since the liquid crystal display has a low utilization ratio of light energy, the brightness of the liquid crystal display is generally insufficient, which is one of problems persecuting many designer.

There are some methods for solving the problem related to the brightness of the liquid crystal display in the related art, including a method of disposing a brightness enhancement film (BEF) between the light source and the liquid crystal panel and a method of disposing a dual brightness enhancement film. The surface of the BEF may include prismatic structures each configured in the same way, and the prismatic structures can reflect and refract light of the back light source to the front side of a user. With two BEFs orthogonal to each other, the visible brightness of the liquid crystal display can be increased by more than 100%. With a multi-film system, the DBEF can reflect back the light with a polarization direction perpendicular to the grid direction of the lower polarizer of the liquid crystal panel to the guiding plate, and transmit light with a polarization direction parallel to the grid direction of the polarizer. The reflected light has been reflected several times in the guiding plate, the polarization direction of a part of light is altered to be parallel to the grid direction of the polarizer and thus enters the liquid crystal layer through the low polarizer, which results in an increase of the brightness of the liquid crystal display.

However, high requirements exist to the technology for fabricating the BEF and DBEF, resulting in an increased cost.

### SUMMARY

The disclosed technology is directed to a back light module comprising a back light source; a guiding plate; and a polarization cube beam splitter (PBS) and an optical converter which are disposed between the back light source and the guiding plate, wherein the PBS is adapted to split light emitted from the back light source into first polarized light and second polarized light with polarization directions perpendicular to each other, and the optical converter is adapted to convert the polarization direction of the second polarized light to be in the polarization direction of the first polarized light, and reflect the first polarized light or the converted second polarized light into the guiding plate.

The disclosed technology is also directed to a liquid crystal display comprising an outer frame, a liquid crystal panel and a back light module, wherein the back light module as described above is used as the back light module in the liquid crystal display, and the polarization direction of the first polarized light matches a lower polarizer in the liquid crystal panel.

Further scope of applicability of the disclosed technology will become apparent from the detailed description given hereinafter. However, it should be understood that the detailed description and specific examples, while indicating preferred embodiments of the disclosed technology, are given by way of illustration only, since various changes and modifications within the spirit and scope of the disclosed technology will become apparent to those skilled in the art from the following detailed description.

### BRIEF DESCRIPTION OF THE DRAWINGS

The disclosed technology will become more fully understood from the detailed description given hereinafter and the accompanying drawings which are given by way of illustration only, and thus are not limitative of the disclosed technology and wherein:

FIG. 1 is a schematic diagram showing an operational principle of a polarization cube beam splitter in a back light module according to first embodiment of the disclosed technology;

FIG. 2 is a schematic diagram showing a simplified configuration of a back light module according to a second embodiment of the disclosed technology;

FIG. 3 is a schematic diagram showing a configuration of a liquid crystal light valve in the back light module according to the second embodiment of the disclosed technology;

FIG. 4 is a schematic diagram showing a liquid crystal orientation of the liquid crystal light valve in the back light module according to the second embodiment of the disclosed technology;

FIG. 5 is a schematic diagram showing an optical path of the back light module according to the second embodiment of the disclosed technology;

FIG. 6 is a schematic diagram showing a front configuration of a back light module according to a third embodiment of the disclosed technology;

FIG. 7 is a schematic diagram showing an optical path of the back light module according to the third embodiment of the disclosed technology;

FIG. 8 is a schematic diagram showing a side configuration of a back light module according to a fourth embodiment of the disclosed technology; and

FIG. 9 is a schematic diagram showing a side configuration of a back light module according to a fifth embodiment of the disclosed technology.

### DETAILED DESCRIPTION

Hereinafter, the embodiments of the disclosed technology will be described in detail with reference to the accompanying drawings so that the objects, technical solutions and advantages of the embodiments of the disclosed technology will become more apparent. It should be noted that the embodiments described below merely are a portion of but not all of the embodiments of the disclosed technology, and thus various modifications, combinations and alterations may be made on basis of the described embodiments without departing from the spirit and scope of the disclosed technology.

### First Embodiment

This embodiment provides a back light module, comprising a back light source, a guiding plate, a polarization cube beam splitter (PBS) and an optical converter. The PBS and the optical converter are disposed between the back light source and the guiding plate.

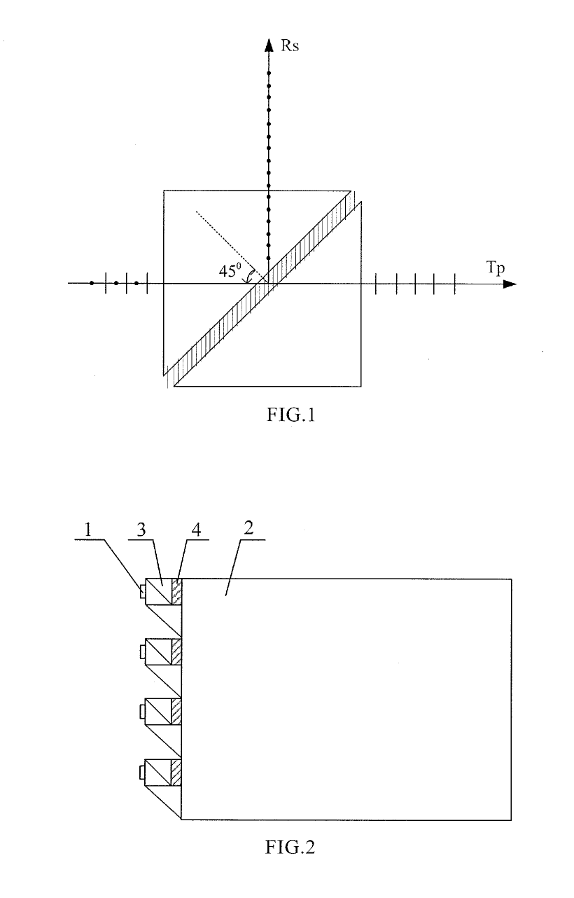

FIG. 1 is a schematic diagram showing an operational principle of a PBS in a back light module according to a first embodiment of the disclosed technology. As shown in FIG. 1, the PBS in this embodiment can split a beam of incident light into two beams of linear polarized light with polarization direction perpendicular to each other, one beam of which is linear polarized light Tp transmitted through the PBS, and the other beam being linear polarized light Rs reflected by the PBS. Here, the linear polarized light Tp transmitted through the PBS is used as transmitted light, and the linear polarized light Rs formed upon being reflected by the PBS is used as reflected light. Correspondingly, the PBS in this embodiment may include a transmitting surface through which the transmitted light exits and a reflecting surface through which the reflected light exits. The transmitting surface and the reflecting surface correspond to two adjacent sides in the cross-section. Specifically, the PBS can be realized by a plurality of configurations. The configuration shown in FIG. 1 with a square cross-section is described as an example in this embodiment. A polarization splitter film is plated on the cross-section shown in a diagonal direction so as to render the incident light polarized. The PBS in this embodiment is configured to split light emitted from the back light source into first polarized light and second polarized light with polarization directions perpendicular to each other, and the polarization direction of the first polarized light matches the lower polarizer. Here, “match” or “matching” means that the polarization direction of the first polarized light is consistent with the polarization direction of the polarized light transmitted by the lower polarizer, and the description thereof is omitted below. Note that, the light absorbing attributes of the lower polarizer in the liquid crystal display can be set as desired. For example, it can be achieved where light with a certain polarization direction can be emitted into the liquid crystal display and light with other polarization direction can be absorbed when passing through the lower polarizer. The polarization direction of the first polarized light in this embodiment matches that of the lower polarizer, and can be emitted into the liquid crystal display upon passing through the lower polarizer. The optical converter in this embodiment is configured to convert the polarization direction of the second polarized light so that the polarization direction thereof matches that of the lower polarizer, and transmits the first polarized light or reflects the converted second polarized light into the guiding plate.

Note that the polarized light obtained in this embodiment has a polarization direction consistent with the polarization direction of light transmitted by the lower polarizer, so it can pass through the lower polarizer totally. However, since linear polarized light is firstly emitted into the guiding plate before passing the polarizer, it is refracted and reflected several times in the guiding plate, and the polarization direction of a fraction of linear polarized light may be altered. Therefore, the lower polarizer may be provided in this embodiment. However, as compared with the case where only 50% of the linear polarized light is transmitted due to polarizing of the lower polarizer, this embodiment can increase the utilization ratio of light remarkably.

The back light module according to this embodiment is provided with a PBS for splitting light emitted from the back light source into first polarized light and second polarized light with polarization directions thereof perpendicular to each other; and an optical converter for converting the polarization direction of the second polarized light to be the same as the polarization direction of the first polarized light, thus converting the second polarized light to be the polarized light matching the lower polarizer, which allows both of the first polarized light and the second polarized emitted from the back light source to be used by the liquid crystal display and thus increase the utilization ratio of light energy in the liquid crystal display. Therefore, it is possible to substantially avoid the defect of insufficient brightness in the liquid crystal display and reduce the amount of the used light sources and power consumption thereof. At the same time, the back light module according to this embodiment is easy to be realized with simple processes and at a low cost.

### Second Embodiment

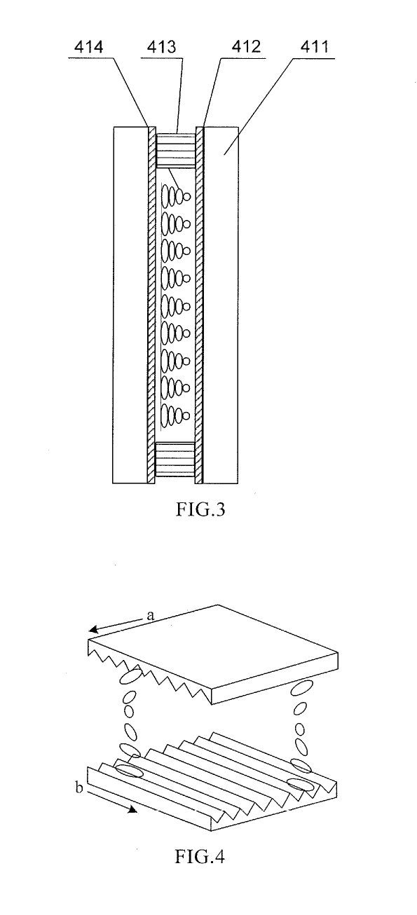

FIG. 2 is a schematic diagram showing a simplified configuration of a back light module according to a second embodiment of the disclosed technology. As shown in FIG. 2, this embodiment will provide a back light module, and particularly a side-emitting back light module is described as an example. The back light module according to this embodiment comprises a light source 1 and a guiding plate 2. The light source 1 is disposed on a side of the guiding plate 2. In this embodiment, light emitting diodes (LEDs) as light sources are described as an example. The back light module according to this embodiment also comprises PBSs 3 and optical converters 4 which are disposed in group between the light source 1 and the guiding plate 2. In addition, in each group the PBS 3 and the optical converter 4 are attached to each other. FIG. 3 is a schematic diagram showing the configuration of a liquid crystal light valve in the back light module according to the second embodiment of the disclosed technology. As shown in FIG. 3, the liquid crystal light valve in this embodiment comprises two glass substrates 411, liquid crystal molecule alignment layers 412, a liquid crystal layer 414 and an epoxy adhesive 413. The two glass substrates 411 are disposed to be opposite to each other. The liquid crystal molecule alignment layers 412 are located on the surfaces of the two glass substrates 411 respectively. The epoxy adhesive 414 and the liquid crystal layer 414 are enclosed between the two liquid crystal molecule alignment layers 412. The epoxy 413 is disposed around the liquid crystal layer 414. In this embodiment, twisted nematic mode is applied to the liquid crystal light valve, and the liquid crystal layer 414 of twisted nematic mode is enclosed between the two glass substrates 411 with the epoxy adhesive 413. The glass substrates 411 are provided with the liquid crystal molecule alignment layers 412 orientated in two orthogonal directions. As shown in FIG. 4, which is a schematic diagram showing the liquid crystal material orientation of the liquid crystal light valve in the back light module according to the second embodiment of the disclosed technology, liquid crystal material is oriented by the liquid crystal molecule alignment layers, thus completing the fabrication of the liquid crystal light valve which can render linear polarized light transmitted through the liquid crystal light valve have its polarization direction rotating 90 degrees. Please note that it is not necessary to fabricate electrodes on the glass substrates due to the use of only optical rotation characteristic the liquid crystal light valve for polarized light in the disclosed technology.

FIG. 5 is a schematic diagram showing the optical path of the back light module according to the second embodiment of the disclosed technology. As shown in FIG. 5, the optical converter includes a liquid crystal light valve 41 and a reflective prism 42. Here, the liquid crystal light valve 41 and the reflective prism 42 are shown separately, just for purpose of more clearly describing the optical path. Specifically, the configuration of the reflective prism 42 in this embodiment can be arranged to be an isosceles right-angled reflective prism, that is, the configuration of the reflective prism 42 can be arranged to have a cross-section of an isosceles right-angled triangle. Light emitted from the light source 1 is emitted into the PBS 3 firstly and is split by the PBS 3 into first polarized light P1 and second polarized light P2 with polarization directions thereof orthogonal to each other depending on the polarization direction of light. The first polarized light P1 in this embodiment is polarized light matching the lower polarizer of a liquid crystal panel. Here, particularly, the first polarized light P1 is transmitted through the PBS 3, and the second polarized light P2 is reflected by the PBS 3. According to this embodiment, the polarization direction of the second polarized light P2 is converted by the liquid crystal light valve 41 to be the same direction as the polarization direction of the first polarized light P1. That is, after the second polarized light P2 passes through the liquid crystal light valve 41, the polarization direction of the second polarized light P2 is rotated by 90 degrees and converted to be in the direction matching the lower polarizer. After having been converted by the liquid crystal light valve 41, the second polarized light P2 is reflected by the reflective prism 42 with the transmitting direction being rotated 90 degree, and then is directed to the guiding plate 2. The first polarized light P1 passing through the PBS 3 is emitted into to the guiding plate.

With reference to FIG. 5, the back light module according to this embodiment may further include a light cover 11 disposed outside of the light source 1. The light cover 11 can be provided to be open only on the side of the guiding plate 2. The inner surface of the light cover 11 is made of a reflective material so as to allow incidence of light emitted from the light source 1 into the guiding plate 2, for preventing light emitted from the light source 1 from leaking out in other directions, resulting in an increased utilization ratio of light energy.

In addition, in this embodiment, as shown in FIG. 5, the PBS 3 is disposed with a reflective film on its surface other than those attached to the light source 1, the liquid crystal light valve 41 and the reflective prism 42. That is, a film with high reflection ratio is plated on the surface so as to further prevent light emitted from the light source 1 from leaking out of the other surfaces after passing through the PBS 3 and direct it into the guiding plate 2 for further increasing the utilization ratio of light energy.

In the embodiment, the back light module is provided with a PBS for splitting light emitted from the back light source into first polarized light and second polarized light with polarization directions thereof orthogonal to each other; and an optical converter having a liquid crystal light valve for converting the polarization direction of the second polarized light to be the same as the polarization direction of the first polarized light and thus converting the second polarized light to be polarized light matching with that of the lower polarizer, which allows both of the first polarized light and the second polarized emitted from the back light source to be directed to the liquid crystal display and thus increases the utilization ratio of light energy in the liquid crystal display. Therefore, it is possible to substantially avoid the defect of insufficient brightness in the liquid crystal display and reduce the amount of the used light sources and power consumption thereof At the same time, the back light module according to this embodiment can be realized easily with simple processes and a low cost.

### Third Embodiment

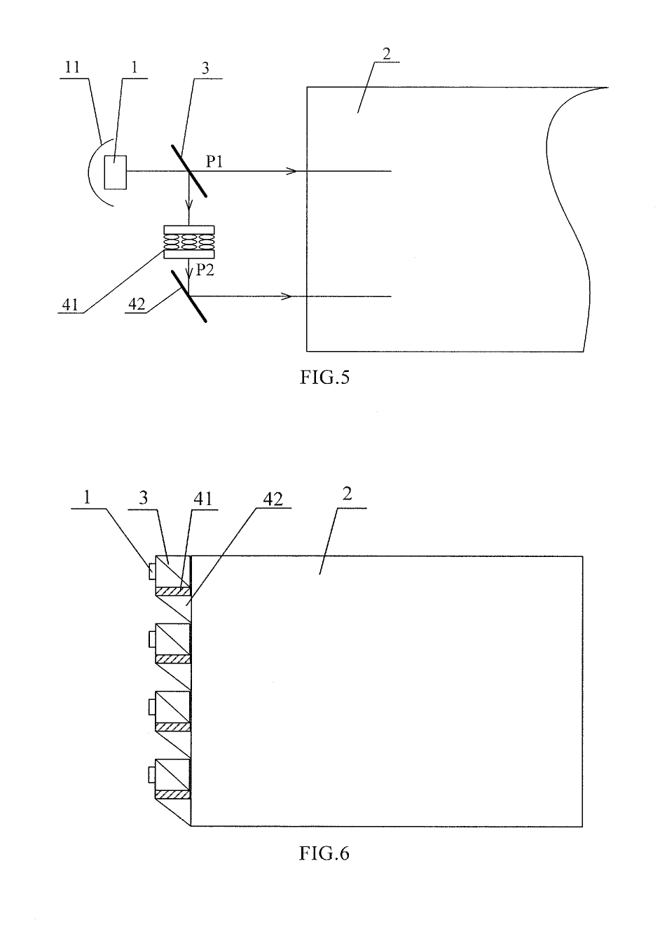

FIG. 6 is a schematic diagram showing a front configuration of a back light module according to a third embodiment of the disclosed technology. As shown in FIG. 6, in this embodiment, LEDs as light sources 1 are described for example. When each light source 1 is an LED, particularly, a plurality LEDs are arranged side by side, the PBS 3 and the optical converters are provided in plurality accordingly. A plurality of PBSs 3 and a plurality of optical converters are arranged to correspond to the plurality of LEDs one by one. That is, one LED can correspond to one PBS 3 and one optical converter. Specifically, the optical converter in the back light module according to this embodiment, for example, may each include a liquid crystal light valve 41 and a reflective prism 42 which are attached to each other. When the first polarized light P1 is reflected light and the second polarized light P2 is transmitted light in this embodiment, the liquid crystal light valve 41 can convert the polarization direction of the second polarized light P2 to be the same direction as the polarization direction of the first polarized light P1. That is, the polarization direction of the second polarized light P2 is converted to be the direction matching the lower polarizer. In this embodiment, specifically, the reflective prism 42 can be used to reflect the first polarized light P1 toward the guiding plate 2, and the converted second polarized light P2 is directed to the guiding plate 2 directly.

Specifically, as shown in FIG. 6, in this embodiment, the transmitting surface of the PBS 3 is attached to the incidence surface of the guiding plate 2, one side of the liquid crystal light valve 41 is attached to the reflective surface of the PBS 3, and the other side of the liquid crystal light valve 41 is attached to non-reflective surface of the reflective prism 42. The PBS 3, the liquid crystal light valve 41 and the reflective prism 42 can be attached to each other by applying an adhesive without affecting optical property thereof

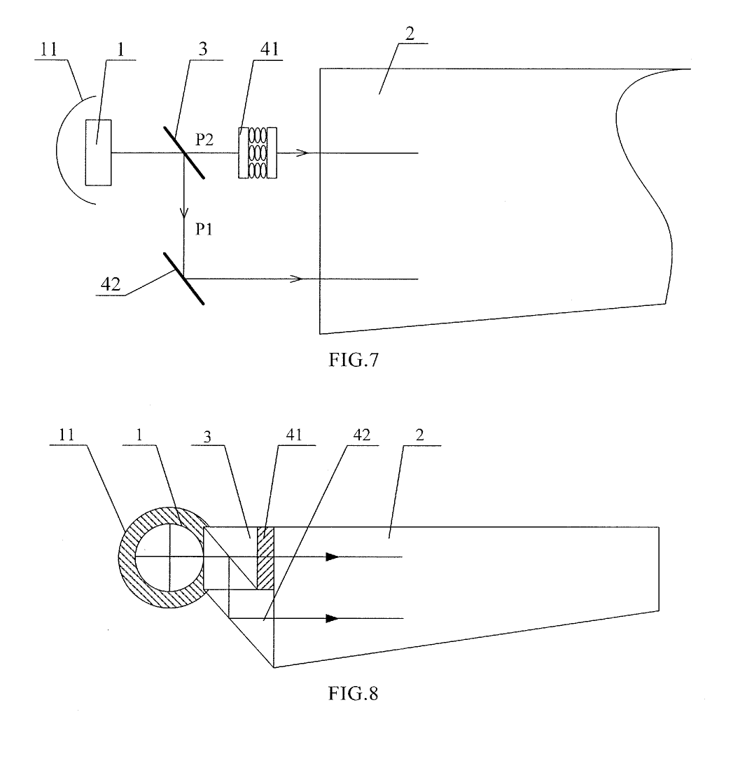

FIG. 7 is a schematic diagram showing the optical path of the back light module according to the third embodiment of the disclosed technology. As shown in FIG. 7, the optical converter includes a liquid crystal light valve 41 and a reflective prism 42. Here, the liquid crystal light valve 41 and the reflective prism 42 are shown separately, also just for purpose of more clearly describing the optical path. Specifically, the configuration of the reflective prism 42 in this embodiment can be arranged to be an isosceles right-angled reflective prism, that is, the side of the reflective prism 42 can be arranged to be an isosceles right-angled triangle. Light emitted from the light source 1 is emitted into the PBS 3 firstly and is split by the PBS 3 into first polarized light P1 and second polarized light P2 depending on the polarization direction of light. The first polarized light P1 is the light reflected by the PBS 3, and the second polarized light P2 is the light transmitted through the PBS 3. In this embodiment, the first polarized light P1 is polarized light matching the lower polarizer. The first polarized light P1 is reflected by the reflective prism 42 with the transmitting direction being rotated 90 degree and then directed to the guiding plate 2 due to its transmitting direction parallel to the guiding plate 2. According to this embodiment, the polarization direction of the second polarized light P2 is converted by the liquid crystal light valve 41 to be the same direction as the polarization direction of the first polarized light P1. That is, after passing through the liquid crystal light valve 41, the polarization direction of the second polarized light P2 is also converted to be in a direction matching the lower polarizer by being rotated 90 degrees. After having been converted by the liquid crystal light valve 41, the second polarized light P2 is directed to the guiding plate 2 due to the transmitting direction thereof orthogonal to the incidence surface of the guiding plate 2.

With reference to FIG. 7, the back light module according to this embodiment may further include a light cover 11 disposed outside of the light source 1. The light cover 11 can be provided to be open only on the side of the guiding plate 2 so as to allow incidence of light emitted from the light source 1 into the guiding plate 2, for preventing light emitted from the light source 1 from leaking out in other directions, resulting in an increased utilization ratio of light energy.

In addition, in this embodiment, as shown in FIG. 7, the PBS 3 is disposed with a reflective film on its surface other than those attached to the light source 1, the liquid crystal light valve 41 and the reflective prism 42. That is, a film with high reflection ratio is plated on this surface so as to further prevent light emitted from the light source 1 from leaking out of the other surfaces after passing through the PBS 3 and direct it into the guiding plate 2 for further increasing the utilization ratio of light energy.

### Fourth Embodiment

FIG. 8 is a schematic diagram showing a side configuration of a back light module according to a fourth embodiment of the disclosed technology. As shown in FIG. 8, in this embodiment, a cold cathode fluorescent lamp (CCFL) as the light source 1 is described as an example. In this case, the light source 1 may include one CCFL. Specifically, the optical converter in the back light module according to this embodiment include a liquid crystal light valve 41 and a reflective prism 42 which are attached to each other. In this embodiment, the liquid crystal light valve 41 is used to convert the polarization direction of the second polarized light to be the same direction as the polarization direction of the first polarized light, that is, to convert the polarization direction of the second polarized light to be the direction matching that of the lower polarizer. The converted second polarized light is directed to the guiding plate 2. In this embodiment. the liquid crystal light valve 41 can redirect the incident polarized light to exit with its polarization direction rotating 90 degree when the liquid crystal light valve 41 is not energized. The reflective prism 42 in this embodiment can be used to reflect the first polarized light toward the guiding plate 2. Specifically, as shown in FIG. 8, one surface of the liquid crystal light valve 41 is attached to the transmitting surface of the PBS 3, the other surface of the liquid crystal light valve 41 is attached to the incident surface of the guiding plate 2, and the non-reflecting surface of the reflective prism 42 is attached to the reflecting surface of the PBS 3 in this embodiment. The PBS 3, the liquid crystal light valve 41 and the reflective prism 42 can be attached to each other by applying an adhesive without affecting optical property thereof.

### Fifth Embodiment

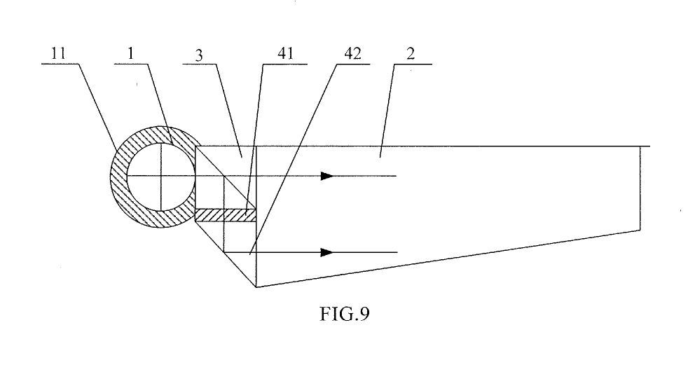

FIG. 9 is a schematic diagram showing a side configuration of a back light module according to a fifth embodiment of the disclosed technology. As shown in FIG. 9, in this embodiment, a cold cathode fluorescent lamp (CCFL) as the light source 1 is also described as an example. Specifically, the optical converter in the back light module according to this embodiment include a liquid crystal light valve 41 and a reflective prism 42 which are attached to each other. In this embodiment, the liquid crystal light valve 41 is used to convert the polarization direction of the second polarized light to be the same direction as the polarization direction of the first polarized light, that is, to convert the polarization direction of the second polarized light to be the direction matching the lower polarizer. The converted second polarized light is directed to the guiding plate 2. This embodiment is different from the embodiment shown in FIG. 8 in that, one surface of the liquid crystal light valve 41 is attached to the reflecting surface of the PBS 3, the other surface of the liquid crystal light valve 41 is attached to the non-reflecting surface of the reflective prism 42, and the transmitting surface of the PBS 3 is attached to the incident surface of the guiding plate in this embodiment.

In the technical solution of this embodiment, the back light module is provided with a PBS for splitting light emitted from the back light source into first polarized light and second polarized light with different polarization directions, i.e., particularly vertical polarized light and horizontal polarized light; and an optical converter having a liquid crystal light valve for converting the polarization direction of the second polarized light to be the same as the polarization direction of the first polarized light and thus converting the second polarized light to be polarized light matching with that of the lower polarizer, which allows both of the horizontal polarized light and the vertical polarized emitted from the back light source to be directed to the liquid crystal display and thus increases the utilization ratio of light energy in the liquid crystal display. Therefore, it is possible to substantially avoid the defect of insufficient brightness in the liquid crystal display and reduce the amount of the used light sources and power consumption thereof. At the same time, the back light module according to this embodiment is easy to be realized with simple processes and low cost.

This embodiment also provides a liquid crystal display comprising an outer frame, a liquid crystal panel and a back light module. The back light module according to any of the first, second, third, fourth and fifth embodiments as described above can be used as the back light module in the liquid crystal display.

It should be appreciated that the embodiments described above are intended to illustrate but not limit the disclosed technology. Although the disclosed technology has been described in detail herein with reference to the preferred embodiments, it should be understood by those skilled in the art that the disclosed technology can be modified and some of the technical features can be equivalently substituted without departing from the spirit and scope of the disclosed technology.

What is claimed is:

1. A back light module comprising:
a back light source;
a guiding plate; and
a polarization cube beam splitter (PBS) and an optical converter which are disposed between the back light source and the guiding plate,
wherein the PBS is adapted to split light emitted from the back light source into first polarized light and second polarized light with polarization directions perpendicular to each other, and
the optical converter is adapted to convert a polarization direction of the second polarized light to be in a polarization direction of the first polarized light, and reflect the first polarized light or the converted second polarized light into the guiding plate.

2. The back light module according to claim 1, wherein, when the first polarized light is transmitted light and the second polarized light is reflected light, the optical converter includes a liquid crystal light valve and a reflective prism attached to each other,
wherein the liquid crystal light valve is configured to convert the polarization direction of the second polarized light to be the same direction as the polarization direction of the first polarized light, and
the reflective prism is configured to reflect the first polarized light into the guiding plate.

3. The back light module according to claim 1, wherein, when the first polarized light is transmitted light and the second polarized light is reflected light, the optical converter includes a liquid crystal light valve and a reflective prism attached to each other,
wherein the liquid crystal light valve is configured to convert the polarization direction of the second polarized light to be the same direction as the polarization direction of the first polarized light, and
the reflective prism is configured to reflect the converted second polarized light into the guiding plate.

4. The back light module according to claim 2, wherein, one surface of the liquid crystal light valve is attached to a transmitting surface of the PBS, the other surface of the liquid crystal light valve is attached to an incident surface of the guiding plate, and a non-reflecting surface of the reflective prism is attached to a reflecting surface of the PBS.

5. The back light module according to claim 3, wherein, a transmitting surface of the PBS is attached to an incident surface of the guiding plate, one side of the liquid crystal light valve is attached to a reflecting surface of the PBS, and the other side of the liquid crystal light valve is attached to a non-reflecting surface of the reflective prism.

6. The back light module according to claim 2, wherein, the liquid crystal light valve comprises two glass substrates disposed to be opposite to each other, liquid crystal molecule alignment layers respectively provided on the two glass substrates, a liquid crystal layer and an epoxy adhesive both disposed between the liquid crystal molecule alignment layers, and the epoxy adhesive is disposed on two ends of the liquid crystal layer.

7. The back light module according to claim 6, wherein, the liquid crystal light valve utilizes twisted nematic liquid crystal, and orientation directions of the liquid crystal molecule alignment layers on the two glass substrate are perpendicular to each other.

8. The back light module according to claim 3, wherein, the liquid crystal light valve comprises two glass substrates disposed to be opposite to each other, liquid crystal molecule alignment layers respectively provided on the two glass substrates, a liquid crystal layer and an epoxy adhesive both disposed between the liquid crystal molecule alignment layers, and the epoxy adhesive is disposed on two ends of the liquid crystal layer.

9. The back light module according to claim 8, wherein, the liquid crystal light valve utilizes twisted nematic liquid crystal, and orientation directions of the liquid crystal molecule alignment layers on the two glass substrate are perpendicular to each other.

10. The back light module according to claim 1, wherein, the back light source comprises a plurality of light emitting diodes arranged side by side, and the PBSs and the optical converters are disposed to correspond to the plurality of light emitting diodes one by one.

11. The back light module according to claim 1, wherein, the back light source comprises a cold cathode fluorescent lamp, and the PBS and the optical converter are disposed to correspond to the cold cathode fluorescent lamp.

12. The back light module according to claim 1, further comprising a light cover disposed outside of the back light source.

13. The back light module according to claim 2, wherein the reflective prism is an isosceles right-angled reflective prism.

14. The back light module according to claim 3, wherein the reflective prism is an isosceles right-angled reflective prism.

15. The back light module according to claim 2, wherein the PBS is disposed with a reflective film on its surface other than those attached to the back light source, the liquid crystal light valve and the reflective prism.

16. The back light module according to claim 3, wherein the PBS is disposed with a reflective film on its surface other than those attached to the back light source, the liquid crystal light valve and the reflective prism.

17. The back light module according to claim 1, wherein the PBS and the optical converter are attached to each other.

18. A liquid crystal display comprising:
an outer frame,
a liquid crystal panel, and
a back light module according to claim 1, and the polarization direction of the first polarized light matches that of a lower polarizer in the liquid crystal panel.
